(19) United States
(12) Patent Application Publication
(10) Pub. No.: US 2008/0216866 A1
(43) Pub. Date: Sep. 11, 2008

(54) Surface Treatment Process and Applicator

(75) Inventors: Mark Coke, East Lothian (GB); Paul Marrs, Hull (GB); James Young, Hull (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, Slough, Berkshire (GB)

(21) Appl. No.: 12/064,488

(22) PCT Filed: Aug. 21, 2006
(86) PCT No.: PCT/GB2006/003097

§ 371 Date: Feb. 22, 2008

(30) Foreign Application Priority Data
Aug. 26, 2005 (GB) 0517471.9

(51) Int. Cl. B08B 7/00; B08B 3/00

(52) U.S. Cl. 134/4; 134/99.1

(57) ABSTRACT

A packaged cleaning composition and process for cleaning a surface involves the simultaneous application of two liquids to the surface, such that a self-supporting gel is formed, acting on soil while delaying it from drying out. The gel and entrained soil are subsequently removed.

The present invention relates to a method for the treatment of surfaces, particularly domestic hard surfaces, and more particularly to the method or treatment of a surface such that the soiled or stained are removed or partially removed from the surface. The present invention also relates to products for use in such methods.

It is known to treat surfaces such as kitchen worktops, enamel ware, bathroom fittings, furniture, glass, carpets, upholstery, wall coverings, clothing, and similar surfaces in the home, or outside the home such as automobile interiors, or exteriors, by applying a liquid cleansing composition, usually an aqueous composition, to the surface to be cleaned. It is then followed by wiping or rubbing the surface with the composition and subsequent removal of the composition, possibly with rinsing.

It is often the case, particularly with situations such as the interior and exterior of ovens, or for crockery or glassware where food remains have dried in place, or for kitchen work surfaces where various remains are dried in place, that vigorous cleaning or the use of an abrasive cleanser is needed in order to remove the soil or staining.

When the spillage or staining of a surface takes place, it is known that the quicker that the soiling or stain is treated, prior to drying out, the better is the chance of successful removal. Conventional treatment with liquids or abrasive cleaners is laborious and may not be convenient at the time when the soiling takes place, e.g. when the food is being prepared or served.

Moreover, the person carrying out the cleaning may need to don protective equipment or may need to wash their hands in order to prevent contamination of cleaning compositions with the food that is being prepared.

If a liquid composition is simply applied, sprayed or poured onto the stain without subsequent immediate removal, then the composition will also dry in place adding to the problem.

Therefore, there is the need to provide convenient stain removal or soil removal system, which alleviates the above mentioned drawback of conventional cleansing with a liquid composition. There is also a need to provide convenient methods for soil or stain removal from soft surfaces such as upholstery, carpets or fabrics without the need for a full conventional washing process. Moreover there is a need to provide a stain or soil removal method which allows for the prevention of stains or soil from drying out in situ.

It is also the case that when treating non horizontal surfaces there is a problem with liquid cleansing compositions in that they tend to run off the surface away from the area where treatment is desired. There is a need to provide a cleaning method that allows for the cleaning composition to remain in place on non vertical surfaces in contact with the soil or stain to be removed.

There is also a need for a suitable method for removing mould and mildew from corners, cracks and crevices in hard surfaces in kitchens and bathrooms, where conventional liquids do not stay in place and where gels may not penetrate.

WO02/102957 discloses textile treatment compositions comprising a patch with a water impervious backing made of a polymer sheet to which is attached a hydrogel containing a surfactant treatment fluid.

Co-pending application PCT2005/GB000428 provides a method of cleaning stains from a surface of the separate application to the surface of two components to form a removable cleaning patch.

WO2004/045783 discloses a method for cleaning cookware and tableware with a film forming liquid dishwashing composition. This composition comprises a film forming polymer, a plasticizer, a cleaning active and a carrier.

Nevertheless, there remains the need for alternative and/or improved methods for the treatment of surfaces, particularly surfaces with dried or baked on soil, for the removal of stains, both in terms of user convenience and stain removal/reduction ability. According to a first aspect, the present invention provides a process for cleaning a soiled surface comprising the steps:
i) simultaneously applying a first and a second liquid onto a common locus of a surface, whereby the liquids are mixed and form a gel comprising a cleaning active adhered to the surface,
ii) leaving the gel in place for a time sufficient to allow the cleaning active to act on the locus of the surface, and
iii) removing the gel from the locus of the surface.

Suitably the gel is formed on a soiled locus of the surface, and the removal of the gel also leads to the removal of soil from the locus of the surface.

Thus in the method of the invention the two components are kept separate from each other in the form of liquids until they are mixed and simultaneously applied to the surface.

The mixing of the liquids may take place first on the surface, or the liquids may be mixed in a mixing region within an applicator used to store the two liquids separately. Alternatively, two jets of liquid may be formed which jets are adapted to collide with each other after dispensing but prior to contacting the surface.

By simultaneously, it is meant that the second component is applied to the same locus of the surface at the same time as the first component is applied, preferably with no time gap between the applications, or where any time gap between the applications is less than one second. The interaction between the two liquid components leads to the formation of a gel (or coagel as it is sometimes described—meaning a liquid with visoelastic properties conferred upon it by virtue of an entangled or crosslinked polymer network or by virtue of interlocking fibrous or plate-like solid particles), which has rheological properties such as to be able to remain in place on non-vertical surfaces immediately after formation, holding the composition in contact with the soil or stain while cleaning takes place, and maintaining a high humidity environment which will prevent the soil or stains from drying out onto the surface if it is applied before the soil or stain has dried out. In the case where the soil or stain has already dried out, then the high moisture content of the gel will enable the soil or stain to reabsorb moisture and soften. Limitation of diffusion through the gel means that the gel will not dry out as rapidly as would a simple liquid composition applied to the soil or stain.

By common locus is meant the same general region or area of the surface to be cleaned. It is not essential for each liquid to be applied at exactly the same place on the surface, so long as the areas of application of the two liquids are substantially overlapping such that the liquids mix together in order to initiate the formation of the gel.

It is preferred that the liquids are predominantly water based, such that the resulting gel is a hydrogel, comprising 60% or more by weight of water, preferably 70% or more, more preferably 75% or more.

The method of the invention is intended for use under ambient conditions in household environments, typically at temperatures from 10° C. to 40° C. Unless otherwise specified, characteristics or parameters of ingredients or compositions used in the invention specified herein are to be measured at 25° C. and a pressure of 1 atmosphere.

When the first and second liquids are simultaneously applied to the surface, the characteristic rheology will change with time after mixing as the gel is formed. Suitably, the gel will be capable of supporting its own weight on a vertical surface for 10 minutes when present as a layer 3 mm or less in thickness, preferably, it will be self-supporting for 10 minutes when present as a layer 5 mm thick or more. Suitably, the gel becomes sufficiently elastic to support its own weight within 10 seconds of completion of application, preferably within 5 seconds, more preferably within 3 seconds.

In order for the gel to be self supporting it should have a value for the storage modulus (usually referred to as G′) measured at 25° C. and 1 Hz of 0.5 Pa or more, preferably 1 Pa or more, more preferably 5 Pa or more. The loss modulus G″ is preferably less than the storage modulus, such that the value of G′/G″ is 2 or more, preferably 5 or more, more preferably 10 or more measured at 1 Hz. The storage modulus may be measured by use of a cone and plate rheometer such as a Bohlin CVO 120 Rheometer, fitted with a 4°, 40 mm cone and plate stainless steel geometry with a gap of 150 micrometres. No pre-shear should be applied, and samples for measurement should be free of air and allowed to rest for 10 minutes before measurement by frequency sweep. The values at 1 Hz are thus obtained.

A suitable gelling system will comprise a gel-precursor in one of the two liquids, and a gelling agent in the other of the two liquids used in the method of the invention. The gel-precursor is either dispersed or dissolved in one of the liquids, preferably dissolved. The gelling agent is either dispersed or dissolved in the other of the liquids, preferably dissolved.

In one preferred embodiment, the gel-precursor is a polymer which is capable of being cross-linked, and the gelling agent is a cross-linking agent. By having the gel precursor in one of the liquids and the cross-linking agent in the other liquid, gel formation does not take place until the two liquids interact and mix when they are simultaneously applied to the surface to be cleaned.

In another preferred embodiment, the gel-precursor is a polymer which gels by swelling when it is made alkaline and the gelling agent is an alkali. When the polymer is in an acidic environment, it is in a compact configuration. When alkaline, this compact configuration is lost and the polymer expands, entangling with other polymer molecules leading to gelation. Carbopol™ Aqua SF-1 is an example of such An alkali swellable acrylic emulsion polymer. Upon neutralisation molecules of the polymer ionize and expand due to change in repulsion of the anionic carboxylate groups in the polymer.

This is known as “hydrodynamic” thickening. It is the change in physical packing of the polymer that causes the gelation.

By having the gel precursor in one of the liquids and the gelling agent in the other liquid, gel formation does not take place until the two liquids interact and mix when they are simultaneously applied to the surface to be cleaned.

Suitable gel-precursors are gel-forming polysaccharides such as carrageenan or agar, gel-forming proteins and synthetic gel-forming polymers such as N-acrylamides and homo or copolymers including acrylate or methacrylate.

Acrylate polymers and copolymers which are useful in the invention include those containing at least one monomer selected from the group consisting of methacrylic acid, acrylic acid, amino acrylic acid, an acrylic acid ester of a C8-30 alkyl, alkylaryl, aryl, heterocyclic, alkoxyl, alkoxyl alkyl ester of a C8-30 alkyl or alkenyl; either substituted or unsubstituted; a methacrylic acid ester of a C8-C30 alkyl, alkylaryl, aryl, heterocyclic, alkoxyl, alkoxyl alkyl ester of a C8-30 alkyl, or alkenyl; either substituted or unsubstituted; a C1-4 alkyl acrylate, and a C1-4 methacrylate; either substituted or unsubstituted, and the like.

The gelling agent is chosen appropriately for the gel-precursor employed. Thus when the gel precursor is carrageenan, the gelling agent is suitably metal ion, preferably potassium ion. Similarly, when the gel-precursor is alginate, the gelling agent is a metal ion, suitably calcium ion. When the gel-precursor is polyvinyl alcohol, the gelling agent is suitably borax ion.

In a preferred embodiment of the invention, the gel-precursor is a polyacrylate polymer, present in a liquid with a pH of 4 or less, preferably 3 or less, more preferably 2.5 or less, and the gelling agent is alkali such as sodium hydroxide present in the other liquid. Preferred alkali gelling agents are sodium hydroxide, monoethanolamine, triethanolamine and mixtures thereof. Alkaline silicates such as Sodium metasilicate are also suitable alkaline gelling agents.

The choice of alkali is not critical, provided that the pH of the two liquids of the method of the invention after mixing upon application to the surface to be cleaned is 4.5 or more, preferably 6 or more, more preferably 8 or more. In this embodiment of the method of the invention, the amount of polyacrylate polymer (expressed in its acid form) is 0.25% by weight or more by weight of the combined liquids, preferably 0.35% or more, more preferably 0.55% or more in order to obtain adequate gelation in a short time. Suitably, the amount of polyacrylate polymer (expressed in its acid form) is less than 4% by weight or more by weight of the combined liquids, preferably less than 3, more preferably less than 2%, in order to avoid excessive rigidity of the gel and difficulties in its subsequent removal.

Suitable polyacrylates for use in the method of the invention are the Carbopol™ polyacrylates supplied by Noveon™. Examples are Aqua SF1 and Aqua SF30.

The two liquids employed in the method of the invention suitably have kinematic viscosities measured at 25° C. using a capillary viscometer of 10,000 mm² sec⁻¹ or less, preferably 1,000 or less, more preferably 100 or less. This allows for good mixing when the two liquids are simultaneously applied to a common locus of a surface.

The gel may be removed from the surface by manually peeling it or scraping it from the surface and subsequently discarding the gel and any entrained soil.

Alternatively, the gel may be removed by a subsequent cleaning process involving a further cleaning composition. For instance, when the process is used on soiled crockery to loosen soil and prevent soil from drying in place, the gel may be removed by conventional or machine dishwashing of the crockery.

The method is particularly suitable where the surface is a hard surface, such as kitchen or bathroom surfaces, and where the soil is mould or mildew. The method is particularly effective at removing such soil from cracks, crevices and corners.

The simultaneous application of the two liquids to the surface to be cleaned can be carried out by any convenient means, for example by using two separate trigger spray applicators fired together at the surface. However it is preferred to provide an applicator comprising two compartments for retaining the two liquids out of contact with each other prior to application onto a common locus on the surface to be cleaned.

A suitable applicator is a device comprising two compartments separated by an impermeable wall, with the two liquids applied from separate heads, nozzles or sprays from the two compartments.

The device may by provided with controlled dosage pumping means to dispense measured volumes of liquid simultaneously from the two compartments. A simple embodiment has each of the two compartments furnished with an exit nozzle, the exit nozzles having their exit orifices side-by side whereby dispensing of the two liquids from the two compartments via the exit nozzles onto a surface leads to the two liquids mixing upon application. Suitable twin-nozzle bottles for use in the method of the invention are disclosed in WO 2005/014427. An alternative device suitable for use with the method of the invention is a dual compartment trigger-activated fluid dispenser as disclosed in EP 0 715 899 A1.

Hence, in another aspect, the invention provides an applicator device for use in the process of the invention, comprising two compartments, separately holding the first and second liquids of the process, and a means for transferring each liquid simultaneously to a common locus of a surface to be cleaned.

The means for transferring each liquid may be a nozzle for dispensing each liquid, each nozzle being connected by a passageway to each compartment, each nozzle having a dispensing orifice such that the liquids are dispensed to the same locus. Dispensing may be effected by inverting the device, or by squeezing the compartments when the compartments have flexible outer walls.

In another embodiment, the means for transferring each liquid may be a pair of pumps, each pump in fluid connection with one of the two liquids, the pumps being actuated simultaneously by a triggering means to pump liquid from each compartment and to dispense each liquid simultaneously to a common locus on a surface to be cleaned.

Suitably, the means for transferring each liquid may further comprise a mixing chamber, for premixing the two liquids during their transfer, or may be otherwise adapted to bring the two liquids into mixing contact during the dispensing of the liquids onto the surface to be cleaned, such as by ensuring that the two streams of liquid collide on exit from the applicator device.

### Cleaning Active

The gel suitably comprises one or more cleaning actives selected from but not limited to surfactants, solvents, enzymes, bleaching agents, germicidal agents, chelating agents and mixtures thereof. The choice of cleaning actives and their levels is limited by the requirement that the cleaning actives should not prevent the required gel formation for the invention.

The gel suitably comprises from 0.05 to 10% by weight of surfactant selected from anionic surfactant, cationic surfactant, amphoteric surfactant, zwitterionic surfactant, non-ionic surfactant and mixtures thereof. Suitable surfactants for use as cleaning agents are present at a level to aid in soil removal without generating excessive foam.

Where surfactant is present in the liquid with the polymer capable of being gelled, it is preferred to use a non-ionic surfactant, preferably an alcohol alkoxylate, to avoid inadvertent gelling on storage. The low-foaming ethoxylate/propoxylate non-ionic surfactants are preferred.

An organic solvent may be present as 0.1 to 10% by weight of the gel, preferably 0.2 to 6%, more preferably 0.3 to 4%.

Suitable organic solvents include, but are not limited to alcohols such as methanol, ethanol, propanol, isopropanols, n-butanol, t-butanol, isobutanol; glycols, (poly)ethylene glycol(s), glycol ethers, (poly)propylene glycol(s); ethylene, diethylene propylene, dipropylene and tripropylene glycol ethers (such as methyl, propyl or butyl ethers), hexylcellosolves, butylcellosolves, methylcellosolves, esters, glycol ether esters ketones and mixtures thereof. A preferred solvent is Dowanol DPnB™ is dipropylene glycol mono-n-butyl ether, because of its partial miscibility with water and its compatibility with carbopol gels.

The gel may suitably comprise from 0.1 to 10% by weight of a bleaching agent, preferably from 0.2 to 6%, more preferably from 0.3 to 4%. Suitable bleaching agents are water-soluble peroxides such as hydrogen peroxide, sodium perborate and sodium percarbonate, or mixtures thereof. Where a peroxide is present in one of the liquids, a peracid precursor such as TAED (tetraacetyl ethylene diamine) is preferably present in the other liquid. A preferred bleaching agent is hydrogen peroxide. PAP (phalamidohexanoic acid peracid) is also a preferred bleach.

The gel may also suitably comprise from 0.1 to 5% by weight of a germicidal agent, preferably a cationic germicidal agent.

The gel may also suitably comprise from 0.1 to 8% by weight of a chelating agent, such as citric acid and/or its alkali metal salts, or EDTA (ethylene diamine tetraacetic acid and/or its alkali metal salts). Such chelating agents are advantageous in breaking alkali earth or heavy metal ion bridges and so enhancing stain and soil removal characteristics of the cleaning composition.

The cleaning active or actives may be present in the first liquid, or in the second liquid, or may be present in both liquids.

In another aspect of the invention, the first liquid may contain a first active, and the second liquid a second active, wherein the first and second actives interact on mixing to for a cleaning active which is lacking in long term storage stability. By lacking in long term storage stability, it is meant that the cleaning active does not maintain its cleaning activity when stored in aqueous solution at 25° C. for more than 24 hours.

For example, the first active could be hydrogen peroxide solution and the second active a peracid precursor such as TAED (tetra-acetyl ethylene diamine). These interact when mixed in aqueous solution or gel to form peracetic acid, a powerful bleaching active lacking in long term stability.

Where the first active in the first liquid is hydrogen peroxide, then it is preferably stored at an acid pH such that it is chemically stable. So in this case, if the gelling agent is an alkali, it should be in the second liquid, separate from the peroxide

As another example, the first active might be an oxidative bleach and the second active an enzyme. On storage for 24 hours in aqueous solution, the bleach would destroy the enzyme. However if the bleach and enzyme are only mixed as the gel is formed, both can separately act as cleaning actives on the soiled surface to be treated.

As another example, the first active could be an oxidising agent and the second active a reducing agent, such that on mixing the first and second reagents interact to generate heat by an exothermic redox reaction. This gives the advantage of heating the gel in order to increase rates of chemical reaction and hence cleaning rates from the cleaning active or actives present in the gel.

The invention will now be further described by reference to the following examples.

### EXAMPLES

In the tables below, A1 and A2 are examples of the first liquid and B1, B2 and B3 are examples of the second liquid.

The formulations were used in the method at a weight:weight ratio of 1:1 to give excellent soil removal as follows: A₁ with B₃, A₂ with B₁ and A₂ with B₃

| | |
|---|---|
| A₁ | A₂ |

| | | | |
|---|---|---|---|
| 10% | Carbopol SF-1 | 10% | Carbopol SF-1 |
| 7% | H₂O₂ | 0.5% | Eurcco HCW7 |
| 5% | Synperonic LFRA30 | 5% | Synperonic LFRA30 |
| To | DI Water | To | DI Water |
| 100% | | 100% | |

| | |
|---|---|
| B₁ | B₃ |

| | | | |
|---|---|---|---|
| 13% | NaOH | 4% | MEA |
| 5% | Synperonic LFRA30 | 5% | Synperonic LFRA |
| 3% | Dowanol DPnB | 3% | Dowanol DPnB |
| To | DI Water | To | DI Water |
| 100% | | 100% | |

B₂

| | |
|---|---|
| 9% | Triethanolamine |
| 5% | Synperonic LFRA30 |
| 3% | Dowanol DPnB |
| To | DI Water |
| 100% | |

All percentages are by weight of ingredient as available commercially.

Eureco HC W7™ is a PAP-cyclodextrin water-soluble complex.

DI Water is deionised water.

Dowanol DPnB™ is dipropylene glycol mono-n-butyl ether.

Synperonic LFRA30™ is an alcohol alkoxylate non-ionic surfactant.

Carbopol SF-1™ is 30% active emulsion of polyacrylate

1. A process for cleaning a soiled surface comprising the steps:
i) simultaneously applying a first and a second liquid onto a common locus of a surface, whereby the liquids are mixed and form a gel comprising a cleaning active adhered to the surface,
ii) leaving the gel in place for a time sufficient to allow the cleaning active to act on the locus of the surface, and
iii) removing the gel from the locus of the surface.

2. A process according to claim 1 wherein the first liquid comprises a polymer capable of gelling and the second liquid comprises a gelling agent.

3. A process according to claim 2 wherein the polymer capable of gelling is a polyacrylate and the gelling agent is an alkali.

4. A process according to claim 1 wherein the gel is capable of supporting its own weight on a vertical surface.

5. A process according to claim 1 wherein the storage modulus of the gel at 25° C. is 0.5 Pa or more.

6. An applicator device adapted for use in the process of according to claim 1, said applicator device, comprising two compartments, separately holding the first and second liquids of the process, and a means for simultaneously transferring each liquid to a common locus of a surface to be cleaned.

7. A process according to claim 1 wherein the gel comprises 60% or more by weight of water.

8. A process according to claim 2 wherein the polymer capable of gelling is selected from: gel-forming polysaccharides, gel-forming proteins, and synthetic gel-forming polymers.

9. A process according to claim 2 wherein the polymer capable of gelling is selected from acrylate polymers and copolymers containing at least one monomer selected from the group consisting of methacrylic acid, acrylic acid, amino acrylic acid, an acrylic acid ester of a C₈₋₃₀ alkyl, alkylaryl, aryl, heterocyclic, alkoxyl, alkoxyl alkyl ester of a C₈₋₃₀ alkyl or alkenyl; either substituted or unsubstituted; a methacrylic acid ester of a C₈-C₃₀ alkyl, alkylaryl, aryl, heterocyclic, alkoxyl, alkoxyl alkyl ester of a C₈₋₃₀ alkyl, or alkenyl; either substituted or unsubstituted; a C₁₋₄ alkyl acrylate, and a C₁₋₄ methacrylate; either substituted or unsubstituted.

10. A process according to claim 2 wherein the polymer capable of gelling is selected from carageenan and alginates.

11. A process according to claim 2 wherein the polymer capable of gelling is selected from polyvinylalcohols.

12. A process according to claim 2 wherein the gelling agent is a metal ion.

13. A process according to claim 2 wherein the gelling agent is a borax ion.

14. A process according to claim 2 wherein the gelling agent is an alkali selected from hydroxides, silicates and alkanolamines.

15. A process according to claim 2 wherein the gel comprises from 0.05 to 10% by weight of a surfactant.

16. A process according to claim 2 wherein the gel comprises from 0.1 to 10% by weight of an organic solvent.

17. A process according to claim 2 wherein the gel comprises from 0.1 to 10% by weight of a bleaching agent.

18. A process according to claim 2 wherein the gel comprises from 0.1 to 5% by weight of a germicidal agent.

19. A process according to claim 2 wherein the gel comprises from 0.1 to 8% by weight of a chelating agent.
